(19) United States
(12) Patent Application Publication
(10) Pub. No.: US 2008/0126935 A1
(43) Pub. Date: May 29, 2008

(54) Audio Visual Entertainment System and Method of Operation

(76) Inventor: Ross James Blomgren, Torrance, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/557,923

(22) Filed: Nov. 8, 2006

(51) Int. Cl. G06F 3/048

(52) U.S. Cl. 715/716

(57) ABSTRACT

There is disclosed a jukebox self-contained audio-visual entertainment system capable of loading, storing, managing, retrieving, and playing music and other recorded audio content and any available related pictorial or video content. Content may be stored in the form of audio, pictorial, and video media files. The audio-visual entertainment system may load audio content from recorded media and may download related meta-data and pictorial content via a network. The stored media may be managed, in part by dragging-and-dropping icons and text elements on a touch panel user interface.

### NOTICE OF COPYRIGHTS AND TRADE DRESS

A portion of the disclosure of this patent document contains material that is subject to copyright protection. This patent document may show and/or describe matter that is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to an entertainment system for retrieving and playing stored audio-visual content.

2. Description of the Related Art

Music reproduction systems, commonly referred to as jukeboxes, are often found in commercial establishments such as bars and restaurants. The earliest jukeboxes collected coins and allowed the customer to select from a plurality of songs stored in a carrousel of 78-rpm or 45-rpm vinyl records. More recently, jukeboxes may collect payment from coins, bills, and credit cards, and may play songs from a carrousel or mechanical array of compact disc (CD) recordings within the Jukebox cabinet, or may present music videos from a library of digital video disc recordings. The most recent jukeboxes play music with accompanying visual information retrieved from an on-line content provider such as the Ecast Network.

### DESCRIPTION OF THE DRAWINGS

FIG. 1 is a line drawing of an audio-visual entertainment system.

FIG. 2 is a line drawing of the user interface to an audio-visual entertainment system.

FIG. 3 is a block diagram of an audio-visual entertainment system.

FIG. 4 is a sample display presentation.

FIG. 5 is a flow chart of the process of operating an audio-visual entertainment system.

### DETAILED DESCRIPTION

Throughout this description, the embodiments and examples shown should be considered as exemplars, rather than limitations on the apparatus and methods disclosed or claimed.

Description of Apparatus

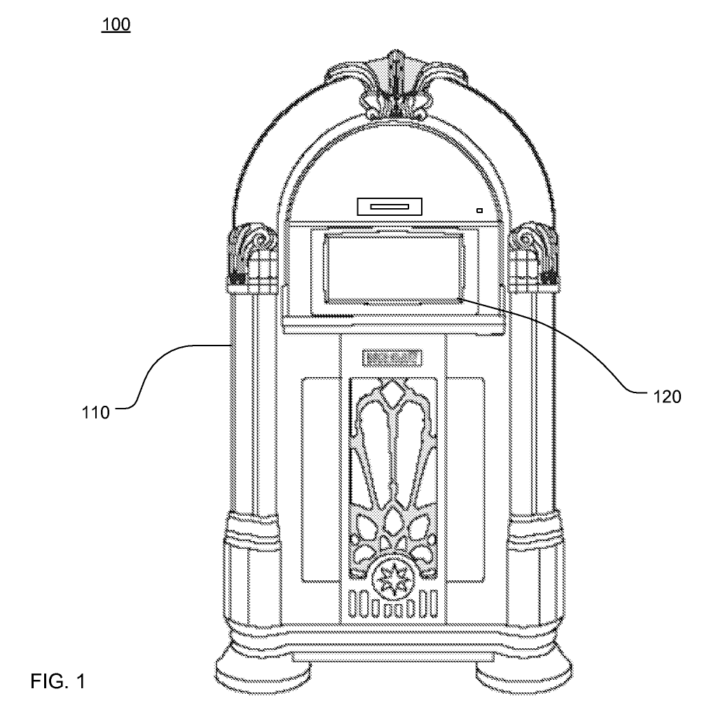

FIG. 1 illustrates a representative audio-visual entertainment system 100 contained with a jukebox cabinet 110. The audio-visual entertainment system 100 is a self-contained system capable of loading, storing, managing, retrieving, and playing music and other recorded audio content and any available related pictorial or video content. While the audio-visual entertainment system 100 may be provided with an interface to a network and with ports or interfaces to a keyboard or other external equipment, these interfaces are not required to perform the basic functions of loading, storing, managing, retrieving, and playing.

The jukebox cabinet 110 may be similar to one of the “nostalgic” jukeboxes described in U.S. Design patent application Ser. No. 29/215,163. Alternatively, the jukebox cabinet 110 may be a furniture-style cabinet or a modern equipment cabinet, or any other type of cabinet sufficient to hold the components of the audio-visual entertainment system 100. Regardless of the cabinet design, the audio-visual entertainment system 100 may provide a display monitor 120 as the primary interface with the user.

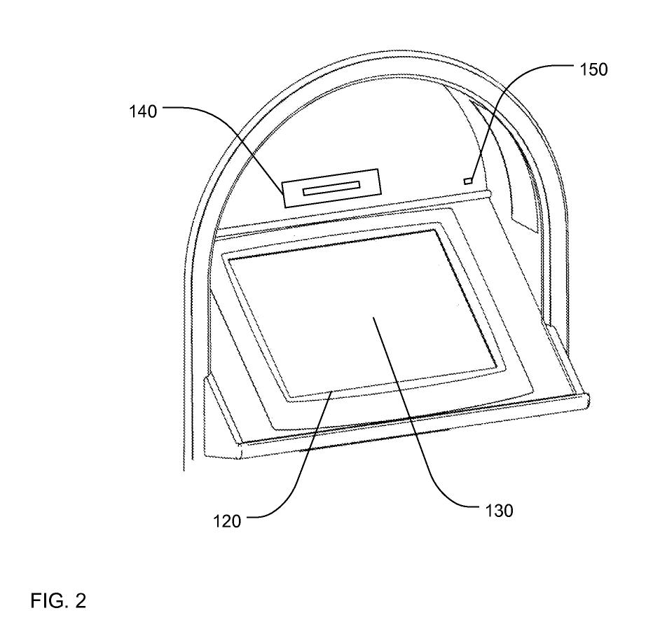

Referring now to FIG. 2, an interface between a user and the audio-visual entertainment system 100 may include a display monitor 120 that may have a touch-panel user interface 130. The touch-panel user interface 130 may be a transparent element that overlays the surface of the display monitor 120 and allows the user to enter commands and requests into the jukebox system by touching the surface of the touch-panel user interface 130. Each touch of the touch-panel user interface 130 may be interpreted as the equivalent of a mouse-click. A touch of the surface followed by motion of the contact point may be interpreted as the equivalent of a mouse “drag and drop” event. Thus, the user may control the audio-visual entertainment system 100 by a combination of touches on icons and text elements presented on the display monitor 120, and by dragging and dropping displayed icons and text elements.

The interface between a user and the audio-visual entertainment system 100 may also include physical access to a recorded media reader 140 and, optionally, a port 150 for connecting external components. Within this description the term “recorded media” means commercially available or custom-recorded physical media containing audio or visual content. The recorded media reader 140 may be a compact disc (CD) drive for reading commercial CD recordings. Alternatively, the recorded media reader 140 may be a digital versatile disc (DVD) drive, a combination CD/DVD drive, a digital audio tape drive, or a media reader for other current or future commercially available recorded media.

The port 150 may be a Universal Serial Bus (USB) port, an RS232 port, a Firewire port, or other current or future port suitable for connecting external devices.

The recorded media reader 140 and the port 150 may be located conveniently on the front of the jukebox cabinet 110, as illustrated in FIG. 2, or may be located on a side or back surface.

Still referring to FIG. 2, note that the interface between a user and the audio-visual entertainment system 100 does not include any form of payment acceptor for accepting payment in the form of coins, bills, credit cards, or other methods of payment. The audio video entertainment system 100 is intended to store, catalog, and play audio content that has already been acquired by the user in the form of a CD or other recorded media. The audio video entertainment system 100 is not intended for use in a commercial setting.

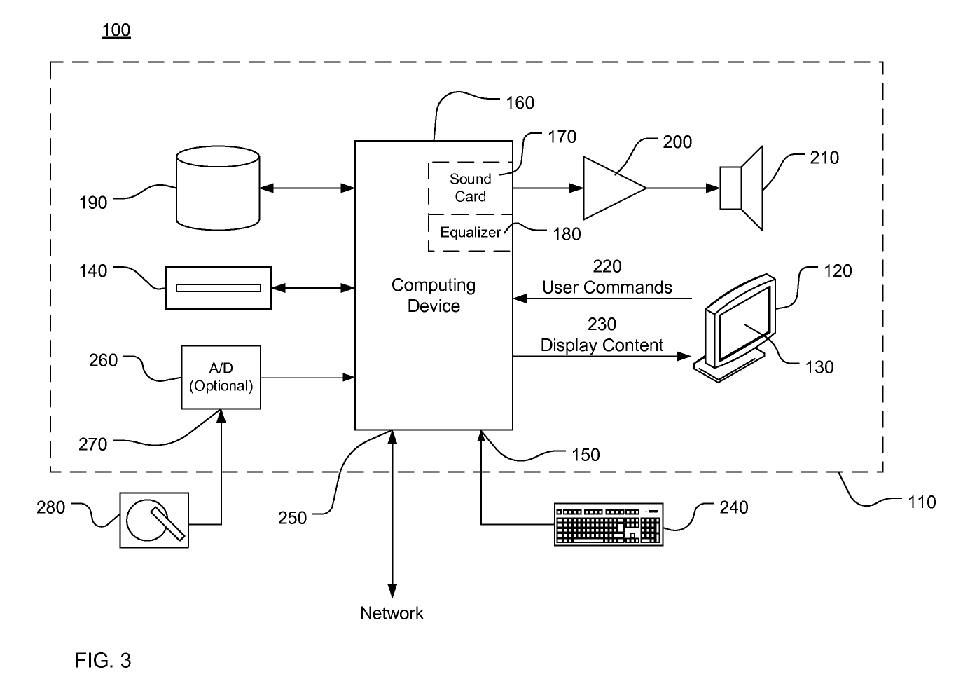

Referring now to FIG. 3, the audio-visual entertainment system 100 may be comprised of a computing device 160, a recorded media reader 140, a storage device 190, the display monitor 120 and the touch-panel user interface 130, and at least one amplifier 200 driving at least one speaker 210.

The computing device 160 may be a device with a processor, memory and a storage device that may execute instructions. The computing device 160 may run an operating system, such as variations of the Linux, Unix, MS-DOS, Microsoft Windows, Palm OS, and Apple Mac OS X operating systems. The computing device 160 may include circuits and software for converting a stored audio media file into one or more audio signals. These circuits and software may be disposed as a sound card 170 within the computing device 160. The computing device 160 may include software and/or circuits for performing audio processing, which may include functions such as an equalizer 180.

The computing device 160 may include software and/or hardware for providing functionality and features described herein. The computing device 160 may therefore include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the computing device 160 may include various specialized units, circuits, software and interfaces for providing the functionality and features described here. The processes, functionality and features may be embodied in whole or in part in software which operates on the computing device 160, and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some components are performed by the computing device 160 and others by other devices.

The storage device 190 may be a hard disc drive. The storage device 190 may be comprised of one or more devices including magnetic media such as hard disks, floppy disks and tape; optical media such as writable compact disks (CD-RW) and writable digital versatile disks (DVD±RW); flash memory cards; and any other current or future device that allows reading and writing to a storage medium. The storage device 190 may store instructions for the computing device 160 as well as audio, pictorial, and video media files.

Audio media files may be stored on the storage device 190 in any of a number of formats including the relatively uncompressed WAVE or Audio Interchange File Format (AIFF). To make more efficient use of available storage capacity, audio media files may be stored on the storage device 190 in a compressed format such as the well-known MP3 format as well as Windows Media Audio (WMA), Real Audio, Apple Lossless, Liquid Audio or Variable Bit Rate (VBR) or other present or future compressed audio file formats. The computing device 160 may contain the software necessary to convert uncompressed content loaded from the recorded media reader 140 to a selected compressed file format for storage on the storage device 190.

The recorded media reader 140 may be a reader/writer capable of writing to a removable storage media such as a CD. A reader/writer would allow one or more stored audio media files to be copies to the removable storage medium. The computing device 160 may contain the software necessary to uncompress compressed stored audio media files where necessary prior to writing to the removable storage medium.

The amplifier 200 may be an analog or digital audio amplifier. The amplifier 200 may include audio processing functions such as automatic level control or equalization. The audio-visual entertainment system 100 may include two or more amplifiers for two or more audio channels, and a plurality of speakers dedicated to different audio channels and/or different frequency portions within the audio channels.

The computing device 160 may interface with the display monitor 120 and the touch-panel user interface 130. The display monitor 120 may be a flat-panel display device. The computing device 160 may include the necessary circuits and software to provide display content 230 to the display monitor 120. The computing device 160 may also include the necessary circuits and software to receive and interpret user commands from the touch-panel user interface 130.

The computing device 160 may include an interface 250 to a network such as the Internet. The computing device 160 may download content related to stored audio media files via the interface 250. Related content may include metadata, pictorial media files such as cover artwork, and video media files such as video performance clips. Such related content may be downloaded from a content provider such as All Media Guide (AMG). Within this description, metadata means non-audio information related to an audio media file and may include such information as track titles and play times; track tempo in beats per minutes; identification of artists, composers, and musicians; identification of era, genre, or other classification; song texts; and cover or jacket notes.

The computing device may also receive audio media files from an on-line content provider via the interface 250. The received audio media files may include files purchased from an on-line music store such as the well-known iTunes.

In some cases, such as CDs published outside of the U.S. or custom compilation CDs, related content may not be available for download. The computing device 160 may have a port 150 for connection to an external device. The port 150 may be used to connect an external keyboard that can be used to manually enter metadata for audio media files where no download is available. The port 150 may also be used to connect to an external portable audio player, such as an iPod or MP-3 player, such that audio media files can be transferred from the audio-visual entertainment system 100 to the external device.

Downloaded or manually-entered metadata and, where available, pictorial and/or video media files may be stored on the storage device 190. Metadata may be indexed or cross-referenced to the corresponding audio, pictorial, and video media files such that the media files can be cataloged, sorted, searched, and selected by means of searches performed on the metadata.

The audio-visual entertainment system 100 may optionally include an analog-to-digital (A/D) converter 260 with an interface 270 to connect to an external analog audio source 280. The external analog audio source 280 may be a phonograph turntable, a cassette tape play, or other device. The external analog audio source 280 is not part of audio-visual entertainment system 100. Analog audio recordings, such as classic phonograph records, may be played on the external device 280, digitized by the A/D converter 260, and converted into audio media files that may be stored on storage device 190.

The audio-visual entertainment system 100 may include an equalizer 180 implemented within computing device 160, or may include an equalizer implemented within amplifier 200. An equalizer is a known circuit or system that divides the audio frequency spectrum into a plurality of bands and allows the relative level or volume to be set independently for each band. The plurality of level set-points for the equalizer bands may be controlled by means of user commands entered via the touch-panel user interface 130. A unique set of equalizer set-points may be selected and stored for each audio media file, and the stored equalizer set-points for a specific audio media file may be automatically recalled and set each time the media file is played.

The audio-visual entertainment system 100 may include the capability of playing a short preview of a selected audio media file, including the capability of interrupting the playback of a first audio media file to provide a preview of a second audio media file. The preview may be 5 to 10 seconds in length. The preview may be the beginning of a selected audio media file or some other portion of the selected audio media file.

Stored audio media files may be managed by means of user commands entered via the touch-panel user interface 130. In this context, “managing” is intended to include sorting, cataloging, searching, selecting, retrieving, playing, editing, deleting, previewing, and any other operation that may be performed upon or with the stored media files. The entry of user commands may be facilitated by presentation of “soft” controls such as buttons and sliders on the display 120. User commands may be entered, at least in part, by touching the touch panel user interface 130 and dragging and dropping a displayed icon or text element.

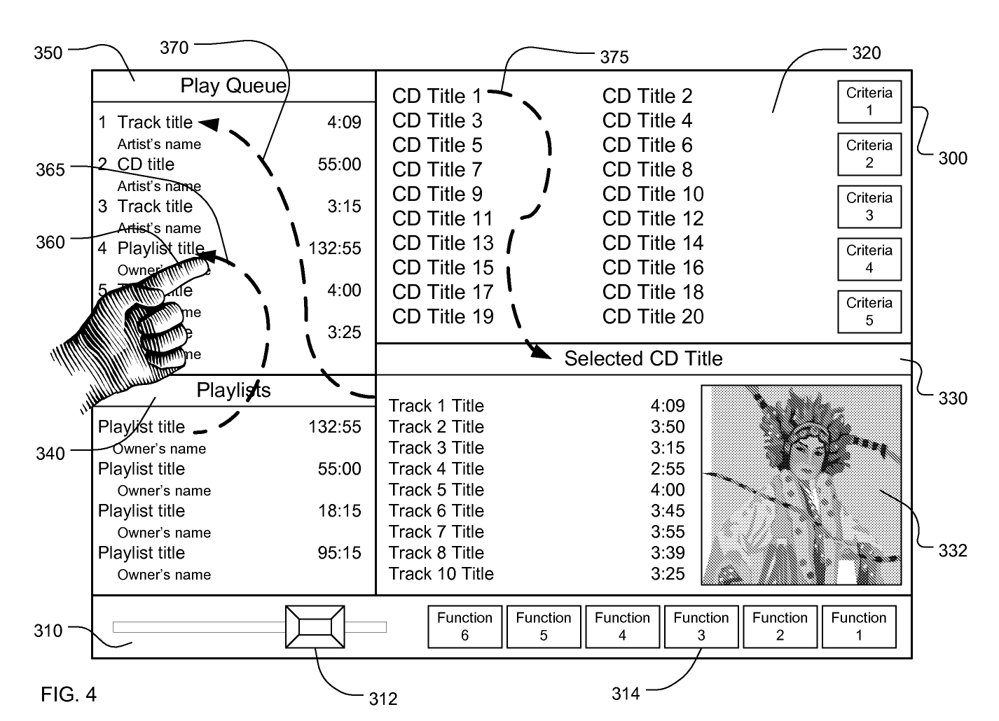

FIG. 4 shows an exemplary format 300 that may be presented on the display device 120 and used for managing media files. The display format 300 may include an area 310 for control of various functions by means of virtual or soft controls such a slider 312 and buttons 314. The display format 300 may include an area 320 for sorting and media files, and an area 330 for detailed presentation of a specific set of media files, such as the files from a single CD). The display format 300 may also include an area 340 for grouping media files into play lists, and an area 350 showing the current queue of media files that have been selected to be played. It must be understood that the areas 310, 310, 330, 340, and 350 are examples that may or may not appear in a specific screen presentation, and may be displayed in any combination or arrangement. It must also be understood that a large plurality of display screen formats may be used to present and manage information in varying levels of detail.

User commands may be entered by means of the touch-panel user interface 130, which overlays the display monitor 120. In the example of FIG. 4, a user 360 may enter commands by touching a button 314 or by touching and then dragging slider 312. The user 360 may also enter commands by touching, dragging, and dropping icons or text elements, as illustrated by arrows 365, 370, and 375. The process for dragging and dropping using the touch-panel user interface 130 is similar to the well-known drag and drop process using a computer mouse. Touching the touch-panel user interface 130 may be equivalent to depressing the left mouse button, moving the finger in contact with the touch panel may be equivalent to moving the mouse with the button depressed, and removing the finger from the touch panel may be equivalent to releasing the mouse button.

The audio-visual entertainment system 100 may receive and store a user profile for one or more users entered either by means of a device connected to the port 150, or by means of commands entered on the touch-screen interface 130. The user profile may contain information on the user such as age, gender, or nationality. The user profile may also contain information on the user's music preferences. The audio-visual entertainment system may include software to recommend a stored audio file for listening based on the user profile, or based on a combination of the user profile and a history of audio files previously selected by the user.

Description of Processes

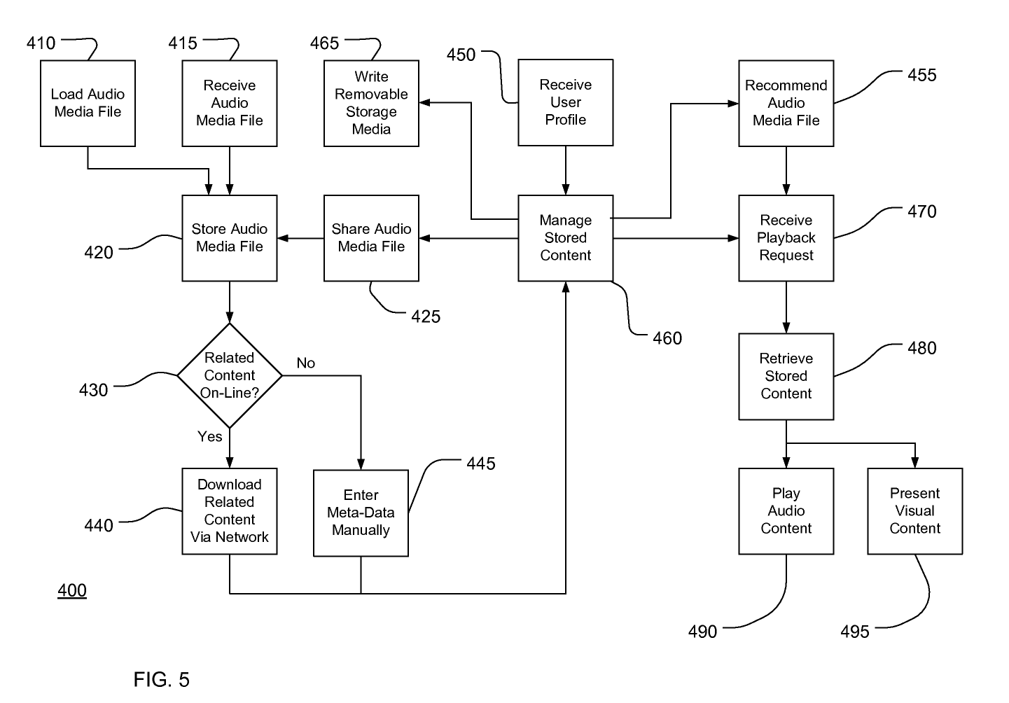

FIG. 5 illustrates the process 400 of operating an audio-visual entertainment system such as the audio-visual entertainment system 100 of FIG. 1. Audio media files may be loaded by means of a recorded media reader at step 410. Audio media files may also be received via a network at step 415, or may be imported from an external file sharing device at step 425. The loaded, received, and imported audio media files may be stored on a storage device within the audio-visual entertainment system at step 420. Audio media files may be loaded individually, or may be loaded as collections of related files, such as the files representing the multiple tracks of a CD recording. At step 430, a query may be made over a network interface and content related to the stored audio media files may be downloaded and stored at step 440. The downloaded related content may include meta-data and pictorial or visual media files. In the event that online content is not available for download, the user may manually enter meta-data at step 450.

The stored audio media files and related content may be managed at step 460 using, at least in part, user commands entered by means of a touch-panel user interface. The user commands may include commands entered by dragging and dropping icons or text elements presented on a display monitor. The step of managing the stored content 460 includes cataloging, sorting, searching, selecting, retrieving, playing, editing, deleting, previewing, and any other process done to or with the stored media files. The step of managing may include determining and storing a plurality of equalizer set-points associated with one or more audio media files. Selected audio media files may be written to a removable storage medium as step 465, or may be exported to the external file-sharing device at step 425.

The audio-visual entertainment system may receive a user-entered user profile at step 450. The user profile may be entered by means of an external keyboard or other device, or may be entered by means of commands on the touch-screen user interface. The audio-visual entertainment system may recommend at least one audio media file at step 455. The recommendation may be based on the user profile, on a history of audio media files selected by the user, or on both the user profile and the user history.

An audio media file selected for playback at step 470 may be retrieved, along with any associated video media files or metadata, from the storage device at step 480. The step of retrieving may include automatically recalling and setting equalizer set-points associated with the selected audio media file. The audio media file may be played at step 490 while any associated video or pictorial content may be presented at 495.

The flow chart of FIG. 4 has an apparent start 410 and an apparent end 490/495, but the process is cyclical in nature, and each of the process steps may be repeated and performed without limit. Moreover, many steps of the process may proceed in parallel. For example, a user may simultaneously catalog previously stored media files (step 460), wait for a new group of audio media files to load from a CD (step 410) and listen to yet another set of stored media files (steps 490/495).

Closing Comments

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. An audio-visual entertainment system, comprising:
a computing device including a processor, memory, and circuits and software for converting a stored audio media file into one or more audio signals
at least one audio amplifier having an input and an output, the input connected to receive an audio signal from the computing device
at least one speaker connected to the output of the audio amplifier
a display monitor including a touch-panel user interface connected to the computing device
a recorded media reader connected to the computing device for loading a plurality of audio media files
a storage device connected to the computing device to store instructions and to store the plurality of audio media files loaded from the recorded media reader
wherein the computing device, the at least one audio amplifier, the at least one speaker, the display monitor including a touch-panel user interface, the recorded media reader, and the storage device are contained within a common cabinet.

2. The audio-visual entertainment system of claim 1, wherein the computing device further comprises an interface to a network

3. The audio-visual entertainment system of claim 2, wherein at least one of metadata, a pictorial media file, and a video media file related to a stored audio media file is downloaded via the network interface and stored on the mass storage device.

4. The audio-visual entertainment system of claim 2, wherein the network interface receives an audio media file from an on-line content provider.

5. The audio-visual entertainment system of claim 1, wherein the computing device further comprises a port for connecting external components.

6. The audio-visual entertainment system of claim 5, wherein metadata related to a stored audio media file may be entered by means of an external keyboard connected to the port for connecting external components.

7. The audio-visual entertainment system of claim 5, wherein audio media files may be shared with an external device via the port for connecting external components.

8. The audio-visual entertainment system of claim 7, wherein the external device is a computing device.

9. The audio-visual entertainment system of claim 8, wherein the external device is a portable audio media player.

10. The audio-visual entertainment system of claim 1, wherein the plurality of stored audio media files and related metadata can be managed by means of user commands entered via the touch-panel user interface,
wherein managed comprises at least one of cataloged, sorted, searched, selected, retrieved, played, edited, deleted, and previewed.

11. The audio-visual entertainment system of claim 10, wherein the user commands are entered, at least in part, by dragging and dropping a displayed icon or text element.

12. The audio-visual entertainment system of claim 1, wherein the system further comprises an analog-to-digital converter having an analog input to interface with an external analog audio source and a digital output connected to the computing device
wherein audio media files can be created and stored from analog recording media read on an external analog media reader connected to said analog input.

13. The audio-visual entertainment system of claim 1, wherein the system further comprises an equalizer having a plurality of set-points controllable by means of user commands entered via the touch-panel user interface.

14. The audio-visual entertainment system of claim 7, wherein the equalizer set-points associated with at least one audio media file are stored.

15. The audio-visual entertainment system of claim 14, wherein the stored equalizer set-points associated with the at least one audio media file are recalled automatically each time the at least one audio media file is played.

16. The audio-visual entertainment system of claim 1, wherein the recorded media reader is a media reader/writer capable of writing stored audio media files to a removable storage medium

17. The audio-visual entertainment system of claim 1, wherein
a user may enter a user profile via the touch-panel user interface
the audio-visual entertainment system recommends stored audio media files based upon the user profile.

18. The audio-visual entertainment system of claim 17, wherein the audio-visual entertainment system recommends stored audio files based upon the user profile and a past history of stored audio files played by the user.

19. A method of operating an audio-visual entertainment system, comprising
providing an audio-visual entertainment system contained within a common cabinet, the audio-visual entertainment system including a computing device, a network interface, a storage medium, a recorded media reader, a display monitor with a touch-panel user interface, at least one audio amplifier, and at least one speaker
loading a plurality of audio media files by means of the recorded media reader
storing the plurality of audio media files on the storage medium
determining, for each stored media file, if related content is available for download, the related content comprising at least one of metadata, a pictorial media file, and a video media file
downloading the related content where available by means of the network interface
storing the downloaded content on the storage media.

20. The method of operating an audio-visual entertainment system of claim 19, wherein the method further comprises providing a port to interface with an external device.

21. The method of operating an audio-visual entertainment system of claim 20, wherein the method further comprises receiving user-entered meta-data by means of an external device connected to the port.

22. The method of operating an audio-visual entertainment system of claim 20, wherein the method further comprises sharing audio media files with an external component connected to the port.

23. The method of operating an audio-visual entertainment system of claim 22, wherein the external device is a computing device.

24. The method of operating an audio-visual entertainment system of claim 22, wherein the external device is a portable audio media player.

25. The method of operating an audio-visual entertainment system of claim 19
wherein the method further comprises managing the stored audio media files and related metadata under control of a user command entered by means of the touch-panel interface
wherein managing further comprises at least one of cataloging, sorting, searching, selecting, retrieving, playing, editing, deleting, and previewing.

26. The method of operating an audio-visual entertainment system of claim 25, wherein the user command is entered by dragging and dropping a displayed icon or text element.

27. The method of operating an audio-visual entertainment system of claim 19
wherein the audio-visual entertain system includes an equalizer having a plurality of set-points
wherein the method further comprises controlling the equalizer set-points by means of user commands entered by means of the touch-panel interface.

28. The method of operating an audio-visual entertainment system of claim 27, wherein the method further comprises storing the equalizer set-points associated with at least one stored media file.

29. The method of operating an audio-visual entertainment system of claim 28, wherein the method further comprises recalling the equalizer set-points associated the at least one stored media file each time the at least one stored media file is played.

30. The method of operating an audio-visual entertainment system of claim 19, wherein the method further comprises receiving an audio media file from an on-line content provider by means of the network interface.

31. The method of operating an audio-visual entertainment system of claim 19,
wherein the recorded media reader is a media reader/writer capable of writing to a removable storage media,
wherein the method further comprises using the recorded media reader to write audio media files to the removable storage medium.

32. The method of operating an audio-visual entertainment system of claim 19, wherein the method further comprises
receiving a user-entered user profile
recommending stored audio media files based upon the user profile.

33. The method of operating an audio-visual entertainment system of claim 32, wherein the method further comprises recommending stored audio media files based upon the user profile and a past history of stored audio media files played by the user.
